(19) United States
(12) Patent Application Publication
(10) Pub. No.: US 2017/0105158 A1
(43) Pub. Date: Apr. 13, 2017

(54) COMMUNICATION CONTROL METHOD, BASE STATION, AND USER TERMINAL

(71) Applicant: KYOCERA CORPORATION, Kyoto (JP)

(72) Inventors: Katsuhiro MITSUI, Kawasaki-shi, Kanagawa (JP); Masato FUJISHIRO, Yokohama-shi, Kanagawa (JP); Yushi NAGASAKA, Yokohama-shi, Kanagawa (JP)

(73) Assignee: KYOCERA CORPORATION, Kyoto (JP)

(21) Appl. No.: 15/126,144

(22) PCT Filed: Mar. 18, 2015
(86) PCT No.: PCT/JP2015/058062

§ 371 Date: Sep. 14, 2016

(30) Foreign Application Priority Data
Mar. 20, 2014 (JP) 2014-059275

(51) Int. Cl. H04W 36/16; H04W 52/02; H04W 24/10

(52) U.S. Cl. CPC H04W 36/165; H04W 24/10; H04W 52/0206

(57) ABSTRACT

In a communication control method according to the present embodiment, an OFF target cell determines at least one cell which becomes a transmission destination of a resource securing notification for securing a resource beforehand for a user terminal from among a plurality of compensation cells for compensating a coverage of the OFF target cell, on the basis of a measurement report received, before turning the OFF target cell off, from the user terminal.

### TECHNICAL FIELD

The present invention relates to a communication control method, a base station, and a user terminal, used in a mobile communication system.

### BACKGROUND ART

According to 3GPP (3rd Generation Partnership Project), which is a project aiming to standardize a mobile communication system, in Release 12 and later, an enhanced energy saving technology is proposed to be introduced (for example, see Non Patent Document 1). For example, when one cell (hereinafter, called an “OFF target cell”) turns off (is deactivated), the transmission power of other neighboring cell (hereinafter, called a “compensation cell”) increases. Thereby, it is possible to extend a coverage of the compensation cell (coverage extension) and to compensate a coverage of the OFF target cell (in other words, area compensation).

Here, when the OFF target cell is turned off, a user terminal, which is connected to the OFF target cell, gets disconnected from the OFF target cell, and therefore, establishes a connection with a compensation cell. In this case, there is a method by which before being turned off, the OFF target cell performs a handover preparation procedure with the compensation cell, and the user terminal executes an RRC Re-establishment with respect to the compensation cell that has performed the handover preparation procedure, after the connection with the OFF target cell gets disconnected.

The handover preparation procedure includes a process of transmitting, by the OFF target cell, to the compensation cell, a resource securing notification for securing a resource beforehand for the user terminal that was connected to the OFF target cell, and a process of securing, by the compensation cell, a resource for a user terminal on the basis of the received resource securing notification.

### PRIOR ART DOCUMENT

### Non-Patent Document

Non Patent Document 1: 3GPP technical report “TR 36.887 V0.2.0” Mar. 10, 2014

### SUMMARY

A communication control method according to one embodiment comprises: determining, by an OFF target cell, at least one cell from among a plurality of compensation cells for compensating a coverage of the OFF target cell, which becomes a transmission destination of a resource securing notification for securing a resource beforehand for a user terminal, on the basis of a measurement report received, before turning the OFF target cell off, from the user terminal.

A base station according to one embodiment comprises: a controller configured to determine, before an OFF target cell is turned off, at least one cell from among a plurality of compensation cells for compensating a coverage of the OFF target cell, which becomes a transmission destination of a resource securing notification for securing a resource beforehand for a user terminal, on the basis of a measurement report received from the user terminal.

A user terminal according to one embodiment comprises: a transmitter configured to transmit a measurement report for an OFF target cell; and a controller configured to connect to at least one cell determined, by the OFF target cell, from among a plurality of compensation cells for compensating a coverage of the OFF target cell, on the basis of the measurement report. The OFF target cell is a cell that plans to disconnect the connection with a user terminal subordinate to the OFF target cell by reducing the transmission power of the OFF target cell.

### BRIEF DESCRIPTION OF THE DRAWINGS

FIG. 1 is a configuration diagram of an LTE system according to an embodiment.

FIG. 2 is a block diagram of a UE according to the embodiment.

FIG. 3 is a block diagram of an eNB according to the embodiment.

FIG. 4 is a protocol stack diagram of a radio interface according to the embodiment.

FIG. 5 is a configuration diagram of a radio frame used in the LTE system according to the embodiment.

FIG. 6 is a diagram for describing an enhanced ES technology according to the embodiment.

FIG. 7 is an explanatory diagram for describing an operation environment according to the embodiment.

FIG. 8 is a sequence diagram showing an operation sequence according to the embodiment.

### DESCRIPTION OF THE EMBODIMENTS

When a plurality of compensation cells perform area compensation, it is assumed that before being turned off, the OFF target cell selects one cell from among a plurality of compensation cells for transmitting a resource securing notification. However, in this case, since the user terminal may not necessarily execute an RRC re-establishment with respect to the compensation cell that receives the resource securing notification, it is feared that the resource secured by the compensation cell may go waste, and at the same time, the user terminal may not be able to quickly establish a connection with the compensation cell.

On the other hand, when the OFF target cell has transmitted a resource securing notification to all of the plurality of compensation cells, the resource secured by the compensation cell for which the user terminal does not execute an RRC re-establishment may go waste.

Therefore, an object of an embodiment is to provide a communication control method, a base station, and a user terminal by which it is possible to appropriately determine a compensation cell from among a plurality of compensation cells for securing a resource beforehand for the user terminal when the user terminal establishes a connection with the compensation cell after the OFF target cell is turned off.

### Overview of Embodiments

A communication control method according to embodiments comprises: determining, by an OFF target cell, at least one cell from among a plurality of compensation cells for compensating a coverage of the OFF target cell, which becomes a transmission destination of a resource securing notification for securing a resource beforehand for a user terminal, on the basis of a measurement report received, before turning the OFF target cell off, from the user terminal.

In the embodiments, the OFF target cell transmits to the user terminal connected to the OFF target cell, measurement setting information for setting a trigger for transmitting the measurement report. The OFF target cell receives the measurement report that is transmitted from the user terminal for which measurement setting is performed on the basis of the measurement setting information.

In the embodiments, the trigger is the fact that a measured value of a radio signal transmitted from a cell other than the OFF target cell becomes better than a threshold value.

In the embodiments, the measurement setting information includes information indicating a plurality of offset values consisting of an offset value associated with each of the plurality of compensation cells. The offset value is a value for adjusting the trigger for the associated compensation cell.

In the embodiments, the offset value is determined depending on the compensation percentage of compensation of a coverage of the OFF target cell by the associated compensation cell.

In the embodiments, the OFF target cell receives setting information concerning the transmission power set in each of the plurality of compensation cells from each of the plurality of compensation cells. The OFF target cell determines each value of the plurality of offset values on the basis of the setting information.

In the embodiments, the OFF target cell receives information indicating each value of the plurality of offset values transmitted from a network apparatus. The network apparatus is an apparatus configured to transmit setting information concerning the transmission power that is set in each of the plurality of compensation cells for compensating a coverage of the OFF target cell.

A base station according to the embodiments comprises a controller configured to determine, before an OFF target cell is turned off, at least one cell from among a plurality of compensation cells for compensating a coverage of the OFF target cell, which becomes a transmission destination of a resource securing notification for securing a resource beforehand for a user terminal, on the basis of a measurement report received from the user terminal.

In the embodiments, the base station further comprises: a transmitter configured to transmit, to a user terminal connected to the OFF target cell, measurement setting information for setting a trigger for transmitting the measurement report; and a receiver configured to receive the measurement report from the user terminal for which measurement setting is performed on the basis of the measurement setting information.

A user terminal according to the embodiments comprises: a transmitter configured to transmit a measurement report for an OFF target cell; and a controller configured to connect to at least one cell determined, by the OFF target cell, from among a plurality of compensation cells for compensating a coverage of the OFF target cell, on the basis of the measurement report, wherein the OFF target cell is a cell that plans to disconnect the connection with a user terminal subordinate to the OFF target cell by reducing the transmission power of the OFF target cell.

### Embodiment

An embodiment of applying the present invention to a LTE system will be described below.

(System Configuration)

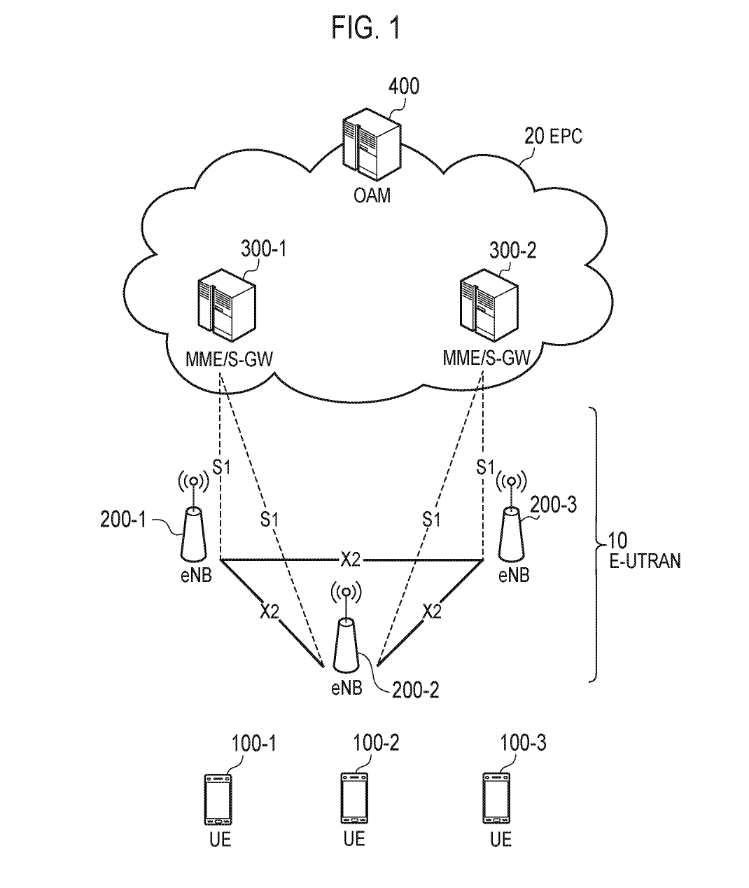

FIG. 1 is a configuration diagram of the LTE system according to the embodiment.

As illustrated in FIG. 1, the LTE system according to the embodiment includes a plurality of UEs (User Equipments) 100, E-UTRAN (Evolved-UMTS Terrestrial Radio Access Network) 10, and EPC (Evolved Packet Core) 20.

The UE 100 corresponds to a user terminal. The UE 100 is a mobile communication device and performs radio communication with a cell (a serving cell). Configuration of the UE 100 will be described later.

The E-UTRAN 10 corresponds to a radio access network. The E-UTRAN 10 includes a plurality of eNBs (evolved Node-Bs) 200. The eNB 200 corresponds to a base station. The eNBs200 are connected mutually via an X2 interface. Configuration of the eNB200 will be described later.

The eNB 200 manages one or a plurality of cells and performs radio communication with the UE 100 which establishes a connection with the cell of the eNB 200. The eNB 200 has a radio resource management (RRM) function, a routing function for user data, and a measurement control function for mobility control and scheduling, and the like. It is noted that the “cell” is used as a term indicating a minimum unit of a radio communication area, and is also used as a term indicating a function of performing radio communication with the UE 100.

The EPC 20 corresponds to a core network. The EPC 20 includes a plurality of MME (Mobility Management Entity)/S-GWs (Serving-Gateways) 300 and an OAM (Operation and Maintenance) 400.

The MME performs various mobility controls and the like for the UE 100. The S-GW performs control to transfer user. MME/S-GW 300 is connected to eNB 200 via an S1 interface.

The OAM 400 is a server apparatus managed by an operator and performs maintenance and monitoring of the E-UTRAN 10.

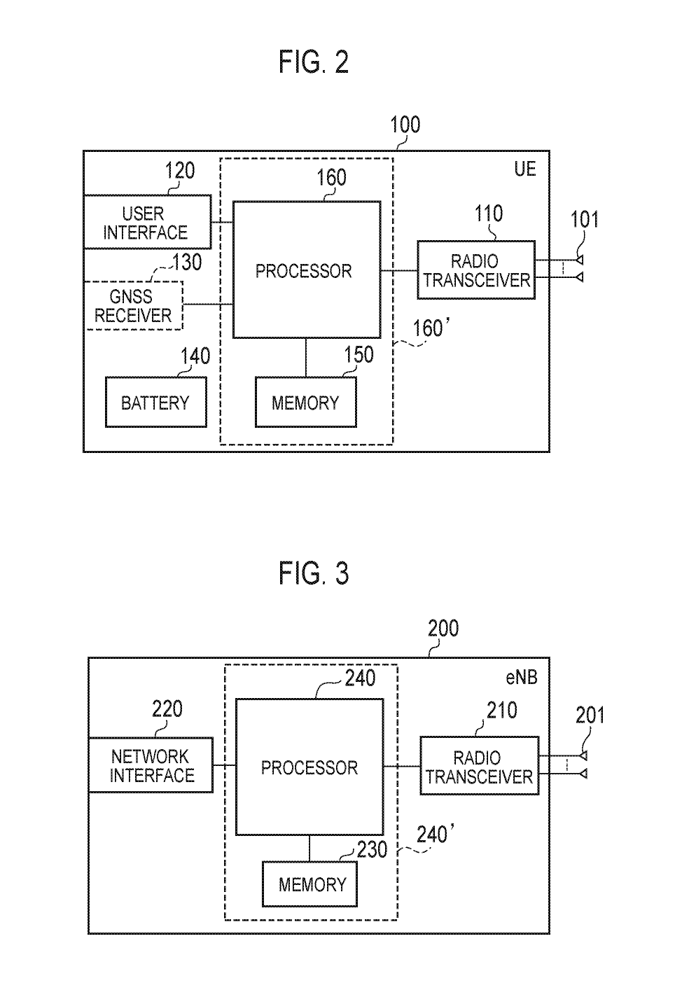

FIG. 2 is a block diagram of the UE 100. As illustrated in FIG. 2, the UE 100 includes plural antennas 101, a radio transceiver 110, a user interface 120, a GNSS (Global Navigation Satellite System) receiver 130, a battery 140, a memory 150, and a processor 160. The processor 160 and the memory 150 constitute a controller. The UE 100 may not have the GNSS receiver 130. Furthermore, the memory 150 may be integrally formed with the processor 160, and this set (that is, a chip set) may be called a processor 160′ which constitutes the controller.

The plural antennas 101 and the radio transceiver 110 are used to transmit and receive a radio signal. The radio transceiver 110 converts a baseband signal (a transmission signal) output from the processor 160 into the radio signal and transmits the radio signal from the antenna 101. Furthermore, the radio transceiver 110 converts a radio signal received by the antenna 101 into a baseband signal (a received signal), and outputs the baseband signal to the processor 160.

The user interface 120 is an interface with a user carrying the UE 100, and includes, for example, a display, a microphone, a speaker, various buttons and the like. The user interface 120 accepts an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates power to be supplied to each block of the UE 100.

The memory 150 stores a program to be executed by the processor 160 and information to be used for a process by the processor 160. The processor 160 includes a baseband processor that performs modulation and demodulation, encoding and decoding and the like on the baseband signal, and CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As illustrated in FIG. 3, the eNB 200 includes plural antennas 201, a radio transceiver 210, a network interface 220, a memory 230, and a processor 240. The processor 240 and the memory 230 constitute a controller. Further, the memory 230 may be integrally formed with the processor 240, and this set (that is, a chipset) may be called a processor 240′ which constitute the controller.

The plural antennas 201 and the radio transceiver 210 are used to transmit and receive a radio signal. The radio transceiver 210 converts a baseband signal (a transmission signal) output from the processor 240 into the radio signal and transmits the radio signal from the antenna 201. Furthermore, the radio transceiver 210 converts a radio signal received by the antenna 201 into a baseband signal (a received signal), and outputs the baseband signal to the processor 240.

The network interface 220 is connected to the neighboring eNB 200 via the X2 interface and is connected to the MME/S-GW 300 via the S1 interface. The network interface 220 is used in communication over the X2 interface and communication over the S1 interface.

The memory 230 stores a program to be executed by the processor 240 and information to be used for a process by the processor 240. The processor 240 includes a baseband processor that performs modulation and demodulation, encoding and decoding and the like on the baseband signal and CPU that performs various processes by executing the program stored in the memory 230. The processor 240 executes various processes and various communication protocols described later.

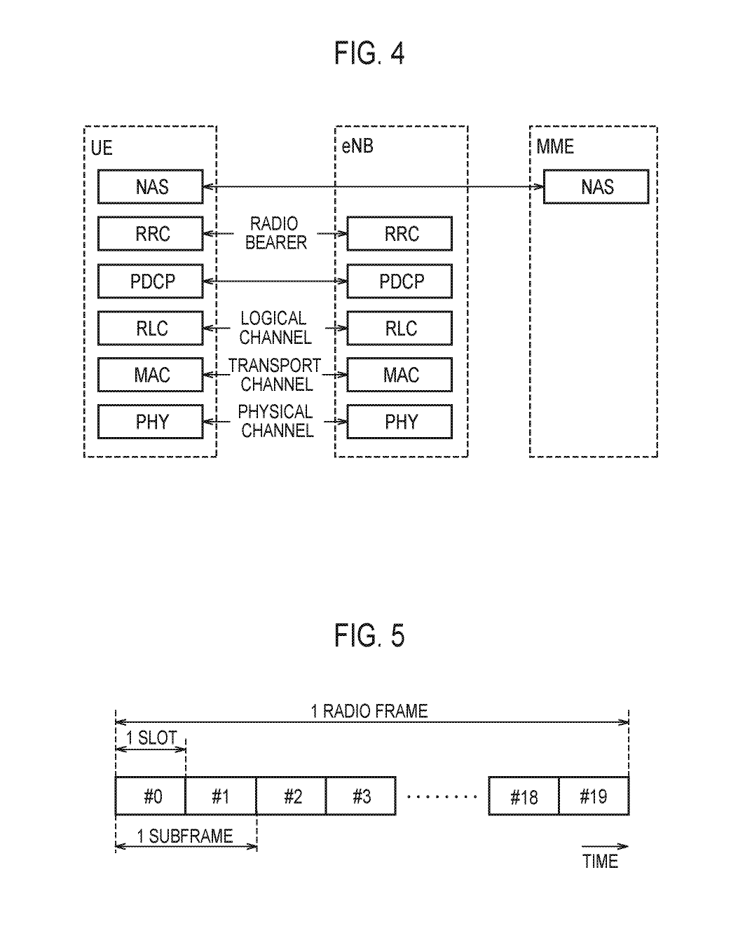

FIG. 4 is a protocol stack diagram of a radio interface in the LTE system. As illustrated in FIG. 4, the radio interface protocol is classified into a layer 1 to a layer 3 of an OSI reference model, wherein the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, use data and control signal are transmitted via the physical channel.

The MAC layer performs priority control of data, a retransmission process by hybrid ARQ (HARQ), a random access procedure at the time of RRC connection establishment and the like. Between the MAC layer of the UE 100 and the MAC layer of the eNB 200, user data and control signal are transmitted via a transport channel. The MAC layer of the eNB 200 includes a scheduler that determines a transport format of an uplink and a downlink (a transport block size and a modulation and coding scheme) and a resource block to be assigned to the UE 100.

The RLC layer transmits data to an RLC layer of a reception side by using the functions of the MAC layer and the PHY layer. Between the RLC layer of the UE 100 and the RLC layer of the eNB 200, user data and control signal are transmitted via a logical channel.

The PDCP layer performs header compression and decompression, and encryption and decryption.

The RRC layer is defined only in a control plane dealing with control signal. Between the RRC layer of the UE 100 and the RRC layer of the eNB 200, control signal (RRC messages) for various types of configuration are transmitted. The RRC layer controls the logical channel, the transport channel, and the physical channel in response to establishment, re-establishment, and release of a radio bearer. When there is an RRC connection between the RRC of the UE 100 and the RRC of the eNB 200, the UE 100 is in an RRC connected state, otherwise the UE 100 is in an RRC idle state.

A NAS (Non-Access Stratum) layer positioned above the RRC layer performs a session management, a mobility management and the like.

FIG. 5 is a configuration diagram of a radio frame used in the LTE system. In the LTE system, OFDMA (Orthogonal Frequency Division Multiple Access) is applied to a downlink, and SC-FDMA (Single Carrier Frequency Division Multiple Access) is applied to an uplink, respectively.

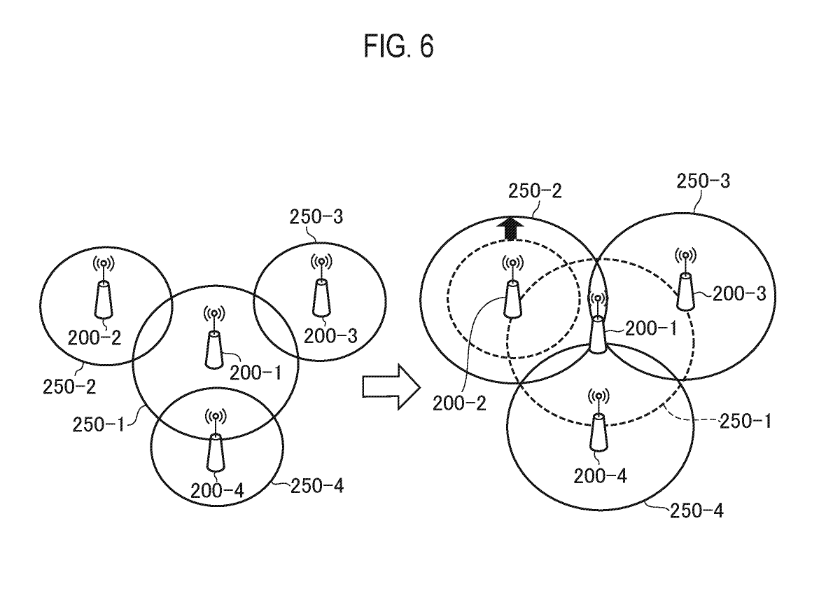

As illustrated in FIG. 6, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. The resource block includes a plurality of subcarriers in the frequency direction. Among radio resources (time-frequency resources) assigned to the UE 100, a frequency resource is specified by a resource block and a time resource is specified by a subframe (or slot).

In the downlink, an interval of several symbols at the head of each subframe is a control region used as a physical downlink control channel (PDCCH) for mainly transmitting a control signal. Furthermore, the other interval of each subframe is a region available as a physical downlink shared channel (PDSCH) for mainly transmitting user data.

In the uplink, both ends in the frequency direction of each subframe are control regions used as a physical uplink control channel (PUCCH) for mainly transmitting a control signal. The remain portion of each subframe is a region available as a physical uplink shared channel (PUSCH) for mainly transmitting user data.

(Overview of ES)

In the LTE system according to the embodiment, an enhanced energy saving (ES) technology (Energy Saving Enhancement) is introduced.

In the enhanced ES technology, a combination of an OFF target cell that is to be turned OFF for power saving, and a compensation cell for compensating a coverage of the OFF target cell when the OFF target cell is turned off has been set. Hereinafter, the OFF target cell will be called an “ES cell (Energy Saving Cell)”, and a compensation cell will be called a “C cell (Compensation Cell)”.

FIG. 6 is a diagram for describing an enhanced ES technology according to the present embodiment. As shown in FIG. 6 (left diagram), the eNB 200-1 manages an ES cell 250-1. The eNB 200-2, the eNB 200-3, and the eNB 200-4 are neighboring eNBs of the eNB 200-1. The eNB 200-2 manages a C cell 250-2, the eNB 200-3 manages a C cell 250-3, and the eNB 200-4 manages a C cell 250-4. Each of the C cell 250-2 through the C cell 250-4 is a neighboring cell of the ES cell 250-1. Each of the eNB 200-2, the eNB 200-3, and the eNB 200-4 can perform communication via at least the eNB 200-1 and the X2 interface.

It is noted that since the UE does not recognize an eNB but a cell, the operation of the eNB 200-1 may be described as the operation of the ES cell 250-1, and the operation of each of the eNB 200-2 through eNB 200-4 may be described as the operation of each of the C cell 250-2 through C cell 250-4, below.

When the ES cell 250-1 is turned OFF, the UE that has established an RRC connection with the ES cell 250-1 performs the process described next in order to quickly establish an RRC connection with any one of the plurality of C cells (the eNB 200-2 through the eNB 200-4).

Firstly, the ES cell 250-1 starts a handover preparation procedure with respect to any of the plurality of C cells.

The handover preparation procedure includes a process of transmitting, by the eNB 200-1 (the ES cell 250-1), to a C cell (for example, the C cell 250-2), a resource securing notification for securing a resource beforehand in the eNB (the cell) that acts as a handover destination candidate for the UE that had established an RRC connection with the ES cell 250-1, and a process of securing, by the eNB 200-2 (the C cell 250-2) that has received the resource securing notification, a resource for the UE on the basis of the received resource securing notification. It is noted that the resource securing notification includes UE context information of the UE that has established an RRC connection.

Secondly, the ES cell 250-1 is turned OFF, and the coverage of the plurality of C cells is extended.

Specifically, the transmission power of the C cell 250-2 rises up to the setting value. Thereby, the coverage of the C cell 250-2 extends so as to cover a part of the coverage of the ES cell 250-1 (see FIG. 6 (right diagram)). Further, each of the C cell 250-3 and the C cell 250-4 extend so as to cover a part of the coverage of the ES cell 250-1, similar to the C cell 250-2. On the other hand, the transmission power of the ES cell 250-1 drops, and the ES cell 250-1 turns off.

Thirdly, due to the ES cell 250-1 turning off, the UE that was connected to the ES cell 250-1 gets disconnected from the ES cell 250-1. Therefore, the UE fails to perform a handover.

Fourthly, the UE that fails to perform a handover executes an RRC re-connection with respect to the C cell that receives the resource securing notification. Since the C cell maintains the UE context information, the RRC re-connection is successful. In addition, since the C cell secures a resource for the UE, the RRC connection can be established quickly.

However, same as the present embodiment, in a case where the occurrence of a coverage hole is prevented when the plurality of C cells perform area compensation, it is not understood that the UE that is connected to the ES cell 250-1 executes an RRC re-connection for which any of the plurality of C cells. Therefore, it is feared that the ES cell 250-1 may start the handover preparation procedure for a C cell for which the UE does not execute an RRC re-connection.

On the other hand, if the ES cell 250-1 starts a handover preparation procedure for all of the plurality of C cells, the resource secured by the C cell for which the UE does not execute an RRC re-connection goes waste.

In order to avoid such a problem, as shown below, the eNB 200-1 (the ES cell 250-1) determines the C cell that will be the transmission destination of the resource securing notification on the basis of the measurement report from the UE.

(Operation Sequence)

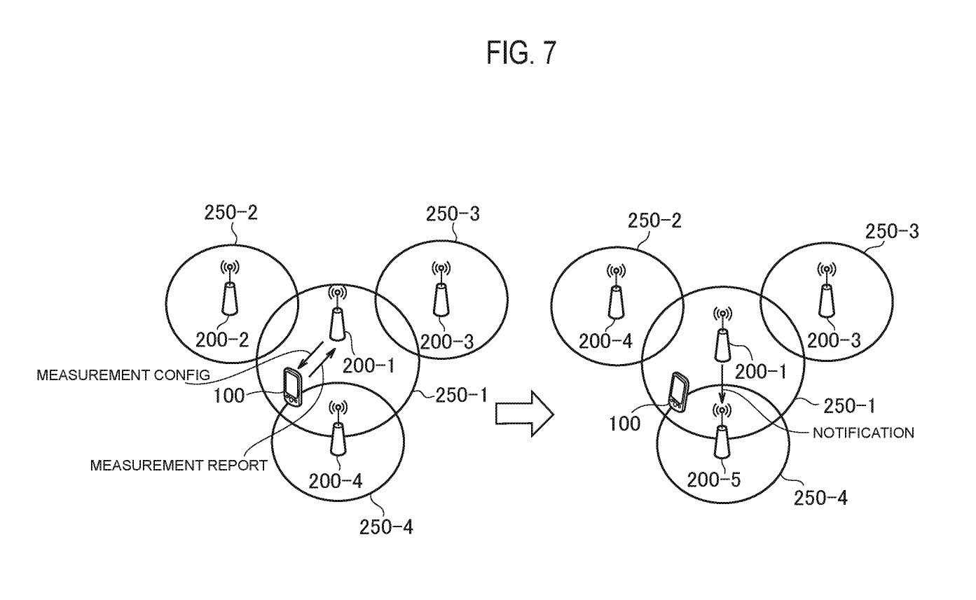

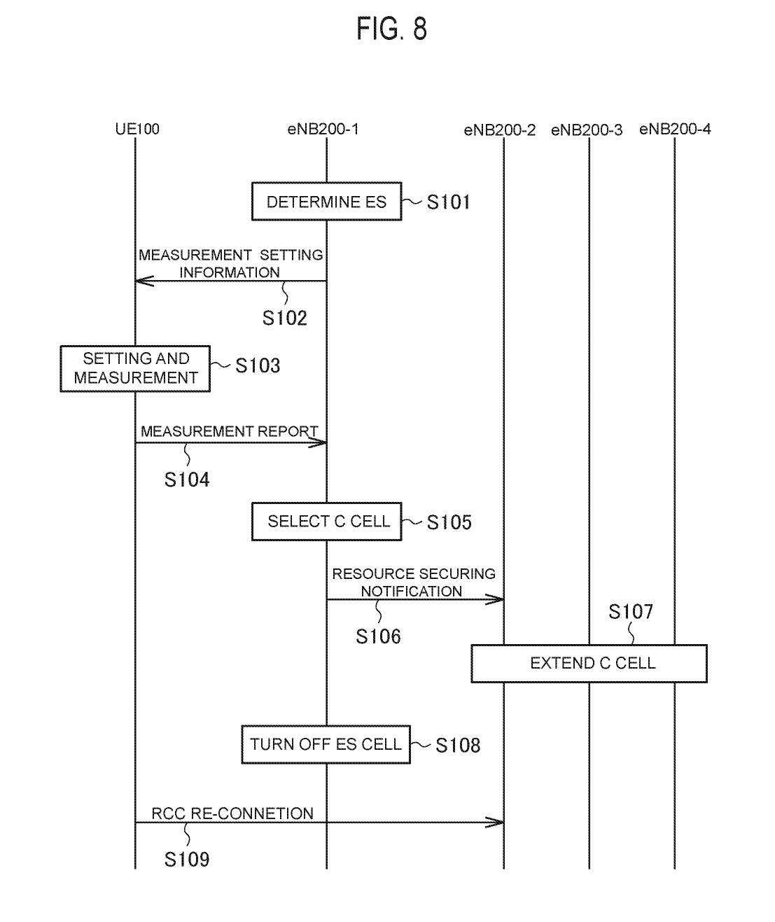

FIG. 7 is an explanatory diagram for describing an operation environment according to the embodiment. FIG. 8 is a sequence diagram showing an operation sequence according to the embodiment. As shown in FIG. 7, the UE 100 is connected to the eNB 200-1 (in other words, the cell 250-1). The other configurations are same as the description provided above.

As shown in FIG. 8, in step S101, the eNB 200-1 determines that the ES cell 250-1 is to be turned off. The eNB 200-1 may determine to turn off the ES cell 250-1 in response to a request from an upper network apparatus (for example, an OAM).

In step S102, as shown in FIG. 7 (left diagram), the eNB 200-1 transmits, to the UE 100, measurement setting information (Measurement Config.) for setting the transmission trigger for transmitting the measurement report before the ES cell 250-1 is turned off.

Here, the measurement setting information includes the information for setting an event A4 rather than an event A3, which is a regular transmission trigger that is set for evaluating the received strength of the cell and the neighboring cell relatively. The fact that the measured value (the received strength) of the radio signal from a neighboring cell has become better than the threshold value is a transmission trigger for the event A4. Specifically, the condition for starting the transmission of the measurement report is shown by the below-mentioned formula.

Mn+Ofn+Ocn−Hys>Thresh

Mn: Measured value of the radio signal from a neighboring cell for which the offset value is not taken into consideration (In the case of RSRP: Unit [dBm]/In the case of RSRQ: Unit [dB])

Ofn: Frequency specification offset value of a neighboring cell

Ocn: Cell specification offset value of a neighboring cell

Hys: Hysteresis parameter

Thresh: Threshold value (same unit as Mn)

Therefore, when the UE 100 performs measurement setting on the basis of the measurement setting information, the measurement report can be transmitted on the basis of the threshold value regardless of the reception status of the radio signal from the ES cell 250-1. Therefore, the measurement report can be transmitted even when the UE 100 is located near the center of the ES cell 250-1.

The measurement setting information may include information indicating a plurality of offset values (Ocn 2 to Ocn 4) consisting of an offset value Ocn associated with each of the plurality of C cells. The offset value Ocn is a value for adjusting the transmission trigger (in other words, the threshold value of the transmission trigger) of the measurement report for the associated C cell. Further, the offset value Ocn is determined depending on the compensation percentage of compensation of the coverage of the ES cell by the associated C cell. The eNB 200-1 may receive, from each of the eNB 200-2 to eNB 200-4, the setting information concerning the transmission power of the C cell when area compensation is performed.

The eNB 200-1 that receives the setting information may determine the compensation percentage of each C cell, and also determine a plurality of offset values depending on the transmission power of each C cell. Specifically, the eNB 200-1 may determine that the larger the difference in the transmission power before and after the extension of the C cell, the larger the compensation percentage. Alternatively, the eNB 200-1 may determine the compensation percentage on the basis of the transmission power of the eNB 200 (the C cell) after area compensation or the information of the coverage area of the C cell after area compensation, and the location information of the eNB 200 that manages the C cell. The eNB 200-1 can, for example, determine that the compensation percentage of the C cell 250-2 is 50%, the compensation percentage of the C cell 250-3 is 30%, and the compensation percentage of the C cell 250-4 is 20%, from the percentage of change of the transmission power. The eNB 200-1 can determine each offset value (the Ocn 2 to the Ocn 4) depending on the compensation percentages. Specifically, the larger the compensation percentage, the larger an offset value that the eNB 200-1 can set, thus being able to satisfy the transmission trigger of the measurement report.

The eNB 200-1 may determine the offset value Ocn on the basis of the setting information received from each of the eNB 200-2 to the eNB 200-4 when the eNB 200-1 determines to turn off the ES cell 250-1, or may determine the offset value Ocn on the basis of the setting information received from each of the eNB 200-2 to the eNB 200-4 when the eNB 200-1 has performed energy saving in the past.

Alternatively, the eNB 200-1 may receive the setting information concerning the transmission power of each C cell from a network apparatus such as OAM. For example, the OAM may transmit, to the eNB 200-1, each setting information together with a request for turning off the ES cell 250-1.

Alternatively, the eNB 200-1 may receive information indicating a plurality of offset values (Ocns) rather than the setting information from the network apparatus. Thereby, it is possible to reduce a load on the eNB 200-1.

The eNB 200-1 is capable of transmitting measurement setting information including information indicating a plurality of offset values (the Ocn 2 to the Ocn 4). For example, the eNB 200-1 is capable of notifying the offset value to the UE 100 by specifying a cellIndividualOffset for each cell. Therefore, the eNB 200-1 is capable of transmitting an RRC connection Reconfiguration message including the cellIndividualOffset of each of the plurality of C cells as an IE, as the measurement setting information.

In step S103, the UE 100 performs measurement setting on the basis of the measurement setting information from the eNB 200-1. Specifically, the UE 100 performs measurement setting in which event A4 is the transmission trigger of the measurement report. Further, the UE 100 performs measurement of the radio signal from each cell on the basis of the measurement setting information.

In step S104, as shown in FIG. 7 (left diagram), when the measured value of the radio signal from the C cell other than the ES cell 250-1 becomes better than the threshold value, the UE 100 transmits the measurement report to the eNB 200-1.

In step S105, the eNB 200-1 determines the C cell that will be the transmission destination of the resource securing notification from among the plurality of C cells, on the basis of the measurement report from the UE 100.

Specifically, the eNB 200-1 determines the C cell corresponding to the measurement report transmitted by the UE 100 as the C cell that will be the transmission destination of the resource securing notification. On the other hand, when the eNB 200 receives a plurality of measurement reports from the UE 100, the eNB 200 determines the C cell corresponding to the highest measured value (the maximum received strength) as the C cell that will be the transmission destination of the resource securing notification. Further, when the eNB 200 receives a plurality of measurement reports from the UE 100, and when there exists a C cell corresponding to a measured value having a small difference with respect to the highest measured value, the eNB 200 may determine not only the C cell corresponding to the highest measured value, but also the C cell corresponding to the measured value having a small difference as the C cell that will be the transmission destination of the resource securing notification. Further, since the measured value of the radio signal from each of the plurality of C cells is lower than the threshold value, the eNB 200-1 may determine all of the plurality of C cells as the transmission-destination C cell for a UE to which the measurement report is not transmitted from among the UEs connected to the ES cell 250-1.

The description proceeds on the assumption that in the present embodiment, the eNB 200-1 determines the C cell 250-4 as the C cell that will be the transmission destination of the resource securing notification.

In step S106, as shown in FIG. 7 (right diagram), the eNB 200-1 transmits the resource securing notification to the C cell 250-4, which is the determined C cell. In other words, the eNB 200-1 starts a handover preparation procedure with respect to the C cell 250-4.

Since the operation of steps S107 to S109 is the same as the operation in “Overview of ES” described above, the description thereof is omitted.

As described above, before the ES cell 250-1 turns off, the eNB 200-1 (the ES cell 250-1) transmits, to the UE 100 connected to the ES cell 250-1, the measurement setting information for setting the event A4. The eNB 200-1 receives the measurement report from the UE 100. Before the ES cell 250-1 turns off, the eNB 200-1 determines the C cell 250-4 that will be the transmission destination of the resource securing notification from among the plurality of C cells, on the basis of the measurement report. Thereby, even if the UE 100 is located near the center of the ES cell 250-1, in other words, even if the transmission of the measurement report is not usually triggered, the UE 100 can report the measurement report. Therefore, the eNB 200-1 can appropriately determine the C cell that will be the transmission destination of the resource securing notification on the basis of the measurement report.

### OTHER EMBODIMENTS

In each of the above-described embodiments, a case in which each of a plurality of cells (the ES cell 250-1, and the C cell 250-2 to the C cell 250-4) belong to a different eNB 200 was illustrated, but, the present application can be applied even to a case in which at least two of the plurality of cells belong to the same eNB 200.

In each of the above-described embodiments, when the eNB 200 does not transmit an offset value to the UE 100, and when the eNB 200 receives a plurality of measurement reports from the UE 100, the eNB 200 may perform weighting in accordance with the compensation percentage of the corresponding C cell to the measured value reported from the UE 100.

Furthermore, in the embodiment described above, although an LTE system is described as an example of a mobile communication system, the present invention is not limited to the LTE system, and may be applied to a system other than the LTE system.

It is noted that the entire content of Japanese Patent Application No. 2014-059275 (filed on Mar. 20, 2014) is incorporated in the present specification by reference.

### INDUSTRIAL APPLICABILITY

As described above, since it is possible according to the communication control method and the base station of the present embodiment to appropriately determine a compensation cell from among a plurality of compensation cells for securing a resource beforehand for the user terminal when the user terminal establishes a connection with the compensation cell after the OFF target cell is turned off, the present invention is useful in the field of mobile communication.

1. A communication control method, comprising:
determining, by an OFF target cell, at least one cell from among a plurality of compensation cells for compensating a coverage of the OFF target cell, which becomes a transmission destination of a resource securing notification for securing a resource beforehand for a user terminal, on the basis of a measurement report received, before turning the OFF target cell off, from the user terminal.

2. The communication control method according to claim 1, further comprising:
transmitting, by the OFF target cell, to the user terminal connected to the OFF target cell, measurement setting information for setting a trigger for transmitting the measurement report; and
receiving, by the OFF target cell, the measurement report that is transmitted from the user terminal for which measurement setting is performed on the basis of the measurement setting information.

3. The communication control method according to claim 2, wherein
the trigger is the fact that a measured value of a radio signal transmitted from a cell other than the OFF target cell becomes better than a threshold value.

4. The communication control method according to claim 2, wherein
the measurement setting information includes information indicating a plurality of offset values consisting of an offset value associated with each of the plurality of compensation cells, and
the offset value is a value for adjusting the trigger for the associated compensation cell.

5. The communication control method according to claim 4, wherein
the offset value is determined depending on the compensation percentage of compensation of a coverage of the OFF target cell by the associated compensation cell.

6. The communication control method according to claim 4, further comprising:
receiving, by the OFF target cell, setting information concerning the transmission power set in each of the plurality of compensation cells from each of the plurality of compensation cells; and
determining, by the OFF target cell, each value of the plurality of offset values on the basis of the setting information.

7. The communication control method according to claim 4, further comprising:
receiving, by the OFF target cell, information indicating each value of the plurality of offset values transmitted from a network apparatus, wherein
the network apparatus is an apparatus configured to transmit setting information concerning the transmission power that is set in each of the plurality of compensation cells for compensating a coverage of the OFF target cell.

8. A base station, comprising:
a controller configured to determine, before an OFF target cell is turned off, at least one cell from among a plurality of compensation cells for compensating a coverage of the OFF target cell, which becomes a transmission destination of a resource securing notification for securing a resource beforehand for a user terminal, on the basis of a measurement report received from the user terminal.

9. The base station according to claim 8, further comprising:
a transmitter configured to transmit, to a user terminal connected to the OFF target cell, measurement setting information for setting a trigger for transmitting the measurement report; and
a receiver configured to receive the measurement report from the user terminal for which measurement setting is performed on the basis of the measurement setting information.

10. A user terminal, comprising:
a transmitter configured to transmit a measurement report for an OFF target cell; and
a controller configured to connect to at least one cell determined, by the OFF target cell, from among a plurality of compensation cells for compensating a coverage of the OFF target cell, on the basis of the measurement report, wherein
the OFF target cell is a cell that plans to disconnect the connection with a user terminal subordinate to the OFF target cell by reducing the transmission power of the OFF target cell.
